(19) United States
(12) Patent Application Publication
(10) Pub. No.: US 2014/0073365 A1
(43) Pub. Date: Mar. 13, 2014

(54) INDICATING INACTIVITY ON A FIRST NETWORK IN RESPONSE TO A DIRECTED PAGE FROM A SECOND NETWORK

(71) Applicant: APPLE INC., Cupertino, CA (US)

(72) Inventors: Anish K. Goyal, Santa Clara, CA (US); Thanigaivelu Elangovan, Santa Clara, CA (US); Li Su, San Jose, CA (US); Jianxiong Shi, Dublin, CA (US)

(73) Assignee: Apple Inc., Cupertino, CA (US)

(21) Appl. No.: 13/622,158

(22) Filed: Sep. 18, 2012

Related U.S. Application Data
(60) Provisional application No. 61/697,871, filed on Sep. 7, 2012.

(51) Int. Cl. H04W 68/00; H04W 4/14

(52) U.S. Cl. 455/458; 455/466

(57) ABSTRACT

Performing wireless communication by a user equipment (UE) device communicating with a first wireless network and a second wireless network using a single radio. The UE device may receive a page message directed to the UE device from the first wireless network. In response to receiving the page message, the UE device may provide an extended service request (ESR) message to the second wireless network. After providing the ESR message, the UE device may respond to the page message on the first wireless network.

### PRIORITY INFORMATION

This application claims benefit of priority of U.S. Provisional Application Ser. No. 61/697,871 titled “Indicating inactivity on a First network in Response to Directed Page from a Second Network” filed Sep. 7, 2012, whose inventors were Anish K. Goyal, Thanigaivelu Elangovan, Li Su, and Jianxiong Shi, which is hereby incorporated by reference in its entirety as though fully and completely set forth herein.

### FIELD OF THE DISCLOSURE

The present application relates to wireless communication, and more particularly to a system and method for indicating inactivity on a first network in response to a directed page from a second network.

### DESCRIPTION OF THE RELATED ART

Wireless communication systems are rapidly growing in usage. Further, wireless communication technology has evolved from voice-only communications to also include the transmission of data, such as Internet and multimedia content.

Some present wireless communication devices (e.g., cell phones) use a single radio for two or more wireless communication technologies, e.g., LTE and CDMA. In such systems, the wireless communication device may periodically tune from the first network to the second network, e.g., to listen to a paging channel. However, sometimes the wireless communication device is required to perform communication on a first network and will be unable to receive a paging message on a second network using the same radio. Accordingly, improvements in wireless communication are desired.

### SUMMARY

Various embodiments are described of a system and method for performing wireless communication by a user equipment (UE) device communicating with a first wireless network and a second wireless network using a single radio.

The UE device may be configured to periodically communicate with the two networks, e.g., with non-overlapping schedules. For example, the UE device may receive messages (e.g., page messages) from the first wireless network in a first time slot and may receive messages (e.g., page messages) from the second wireless network at a second, different time slot. At other times, the UE device may enter a sleep state in order to preserve battery life.

During one of the first time slots, the UE device may receive a first message (e.g., a page message) directed to the UE device from the first wireless network. For example, the first message may identify that the first message is directed to the UE device using an identification number or string of characters (ID) associated with the UE device. Accordingly, the UE device may determine that the received first message is directed to the UE device based on the ID. The first message may indicate an incoming voice call, a short message service (SMS) message, an incoming data call, a service provisioning message, etc., that may require a response from the UE device (e.g., to answer the voice call).

However, because responding to the first message will require utilization of the single radio for communication on the first wireless network for an extended period of time, the UE device may not be able to receive messages from or otherwise communicate with the second wireless network during that period of time. For example, where the first message indicates an incoming voice call, the single radio will be used for the voice call on the first wireless network and will not be able to receive messages from the second wireless network during the period of time. Accordingly, before responding to the first message, the UE device may send a message (e.g., an extended service request (ESR) message) to the second wireless network indicating that the UE device will not be communicating with the second wireless network during the period of time. While sending the message to the second wireless network, the UE device may not be able to monitor a paging channel of the first wireless network, as would normally be the case.

After sending the message, and possibly receiving an acknowledgement from the second wireless network, the UE device may respond to the first message, e.g., to accept a voice call on the first wireless network.

After completion of the actions required by the first message (e.g., completion of the voice call), the UE device may return to normal operation, e.g., receiving messages from both wireless networks using the single radio. The UE device may provide a message to the second wireless network to resume communication with the second wireless network.

### BRIEF DESCRIPTION OF THE DRAWINGS

A better understanding of the present subject matter can be obtained when the following detailed description is considered in conjunction with the following drawings:

FIG. 1 illustrates an exemplary wireless communication system where multiple user devices communicate with a base station, according to one embodiment;

FIG. 2 illustrates a base station 102 in communication with user equipment 106;

FIG. 3 illustrates an exemplary block diagram of a UE device 106, according to one embodiment;

FIG. 4 is a flowchart diagram illustrating one embodiment of a method for performing wireless communication by a UE device communicating with a first and second wireless network using a same radio; and

FIG. 5 illustrates a timing diagram for communication two multiple networks by a UE 106, according to one embodiment.

While features described herein are susceptible to various modifications and alternative forms, specific embodiments thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION

### Terms

The following is a glossary of terms used in the present application:

Memory Medium—Any of various types of memory devices or storage devices. The term “memory medium” is intended to include an installation medium, e.g., a CD-ROM, floppy disks, or tape device; a computer system memory or random access memory such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. The memory medium may include other types of memory as well or combinations thereof. In addition, the memory medium may be located in a first computer system in which the programs are executed, or may be located in a second different computer system which connects to the first computer system over a network, such as the Internet. In the latter instance, the second computer system may provide program instructions to the first computer system for execution. The term “memory medium” may include two or more memory mediums which may reside in different locations, e.g., in different computer systems that are connected over a network.

Carrier Medium—a memory medium as described above, as well as a physical transmission medium, such as a bus, network, and/or other physical transmission medium that conveys signals such as electrical, electromagnetic, or digital signals.

Programmable Hardware Element—includes various hardware devices comprising multiple programmable function blocks connected via a programmable interconnect. Examples include FPGAs (Field Programmable Gate Arrays), PLDs (Programmable Logic Devices), FPOAs (Field Programmable Object Arrays), and CPLDs (Complex PLDs). The programmable function blocks may range from fine grained (combinatorial logic or look up tables) to coarse grained (arithmetic logic units or processor cores). A programmable hardware element may also be referred to as “reconfigurable logic”.

Computer System—any of various types of computing or processing systems, including a personal computer system (PC), mainframe computer system, workstation, network appliance, Internet appliance, personal digital assistant (PDA), television system, grid computing system, or other device or combinations of devices. In general, the term “computer system” can be broadly defined to encompass any device (or combination of devices) having at least one processor that executes instructions from a memory medium.

User Equipment (UE) (or “UE Device”)—any of various types of computer systems devices which are mobile or portable and which performs wireless communications. Examples of UE devices include mobile telephones or smart phones (e.g., iPhone™, Android™-based phones), portable gaming devices (e.g., Nintendo DS™, PlayStation Portable™, Gameboy Advance™, iPod˜), laptops, tablets (e.g., iPad™, Android™-based tablets), PDAs, portable Internet devices, music players, data storage devices, or other handheld devices, etc. In general, the term “UE” or “UE device” can be broadly defined to encompass any electronic, computing, and/or telecommunications device (or combination of devices) which is easily transported by a user and capable of wireless communication.

Base Station—The term “Base Station” has the full breadth of its ordinary meaning, and at least includes a wireless communication station installed at a fixed location and used to communicate as part of a wireless telephone system or radio system.

Automatically—refers to an action or operation performed by a computer system (e.g., software executed by the computer system) or device (e.g., circuitry, programmable hardware elements, ASICs, etc.), without user input directly specifying or performing the action or operation. Thus the term “automatically” is in contrast to an operation being manually performed or specified by the user, where the user provides input to directly perform the operation. An automatic procedure may be initiated by input provided by the user, but the subsequent actions that are performed “automatically” are not specified by the user, i.e., are not performed “manually”, where the user specifies each action to perform. For example, a user filling out an electronic form by selecting each field and providing input specifying information (e.g., by typing information, selecting check boxes, radio selections, etc.) is filling out the form manually, even though the computer system must update the form in response to the user actions. The form may be automatically filled out by the computer system where the computer system (e.g., software executing on the computer system) analyzes the fields of the form and fills in the form without any user input specifying the answers to the fields. As indicated above, the user may invoke the automatic filling of the form, but is not involved in the actual filling of the form (e.g., the user is not manually specifying answers to fields but rather they are being automatically completed). The present specification provides various examples of operations being automatically performed in response to actions the user has taken.

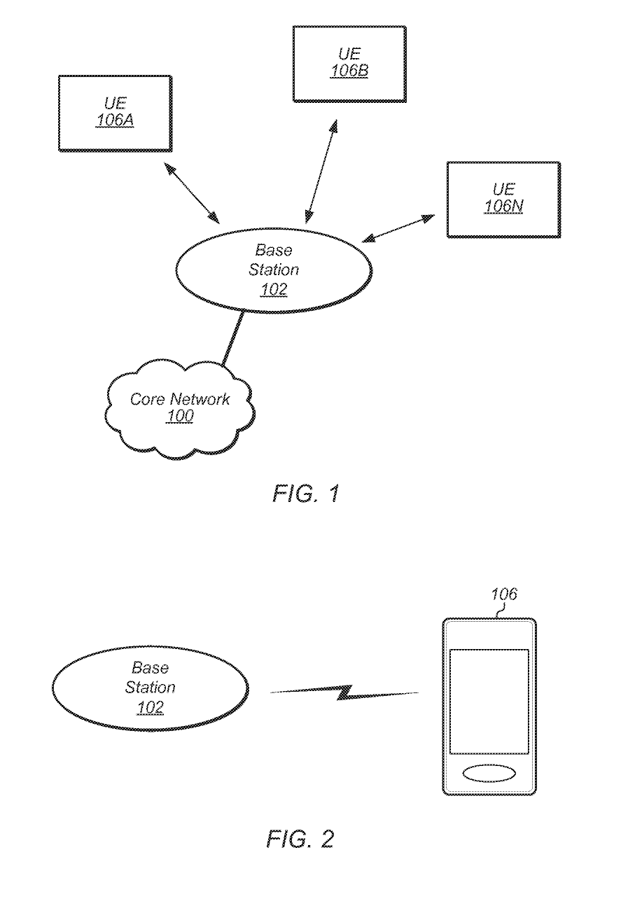

FIGS. 1 and 2—Exemplary Communication System

FIGS. 1 and 2 illustrate an exemplary (and simplified) wireless communication system. It is noted that the system of FIG. 1 is merely one example of a possible system, and embodiments may be implemented in any of various systems, as desired.

As shown, the exemplary wireless communication system includes a base station 102 which communicates over a transmission medium with one or more User Equipment (UE) (or “UE devices”) 106A through 106N.

The base station 102 may be a base transceiver station (BTS), base station controller (BSC), evolved node B (eNB), etc. The base station may be housed within a cell tower, e.g., among one or more other base stations. The base station 102 may include hardware that enables wireless communication with the UEs 106A through 106N. The base station 102 may also be equipped to communicate with a core network 100. Thus, the base station 102 may facilitate communication between the UEs and/or between the UEs and the core network 100. The communication area (or coverage area) of the base station may be referred to as a “cell.” The base station 102 and the UEs may be configured to communicate over the transmission medium using any of various wireless communication technologies such as GSM, CDMA, WLL, WAN, WiFi, WiMAX, LTE, etc.

In some embodiments, the base station may be a multi-mode base station which is configured to support multiple wireless communication technologies (e.g., LTE and CDMA). Alternatively, there may be multiple base stations supporting respective wireless communication technologies, e.g., that are coupled to the same core network 100, although multiple core networks are also envisioned. For example, one of the UE 106 may communicate with two different base stations using two different communication technologies within the same cell.

The core network may be coupled to other various networks which enable communication to other devices, e.g., PSTN, PDN, various wide area networks (WANs) such as the Internet, etc. In some technologies, such as LTE, the core network may include a mobility management entity (MME). The MME may be configured to receive and/or provide messages to a UE 106 in the manner described below. For example, the MME may be configured to receive extended service request (ESR) messages from a UE.

FIG. 2 illustrates UE 106 (e.g., one of the devices 106A through 106N) in communication with the base station 102. The UE 106 may be a device with wireless network connectivity such as a mobile phone, a hand-held device, a computer or a tablet, or virtually any type of wireless device. The UE 106 may include a processor that is configured to execute program instructions stored in memory. The UE may perform any of the embodiments described herein by executing such stored instructions. The UE may include a programmable hardware element such as an FPGA (field-programmable gate array) that is configured to perform any of the method embodiments described herein, or any portion of any of the method embodiments described herein.

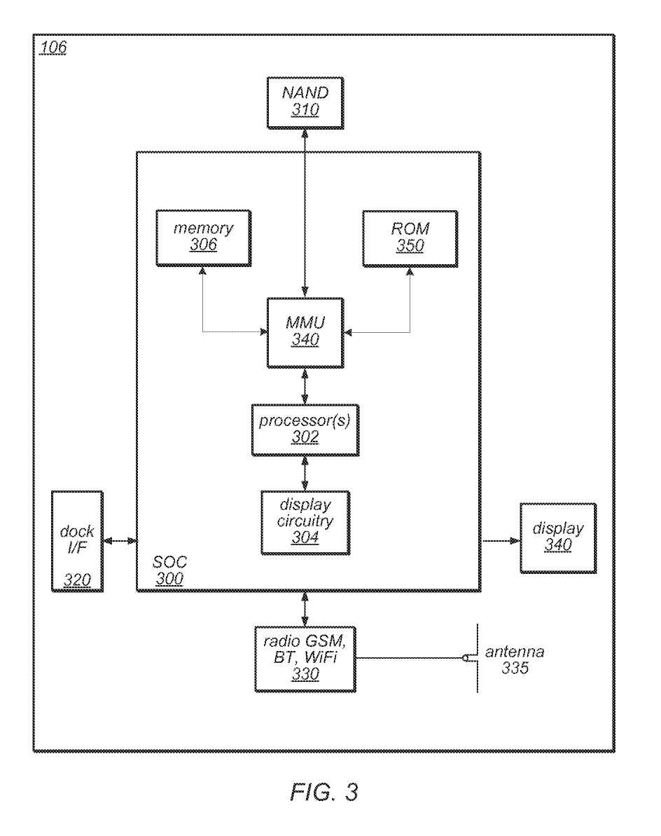

FIG. 3—Exemplary Block Diagram of a UE

FIG. 3 illustrates an exemplary block diagram of the UE 106. As shown, the UE 106 may include a system on chip (SOC) 300, which may include portions for various purposes. For example, as shown, the SOC 300 may include processor(s) 302 which may execute program instructions for the UE 106 and display circuitry 304 which may perform graphics processing and provide display signals to the display 340. The processor(s) 302 may also be coupled to memory management unit (MMU) 340, which may be configured to receive addresses from the processor(s) 302 and translate those addresses to locations in memory (e.g., memory 306, read only memory (ROM) 350, NAND flash memory 310) and/or to other circuits or devices, such as the display circuitry 304, radio 330, connector IF 320, and/or display 340. The MMU 340 may be configured to perform memory protection and page table translation or set up. The MMU 340 may be included as a portion of the processor(s) 302.

As also shown, the SOC 300 may be coupled to various other circuits of the UE 106. For example, the UE 106 may include various types of memory (e.g., including NAND flash 310), a connector interface 320 (e.g., for coupling to the computer system), the display 340, and wireless communication circuitry 330 (e.g., for LTE, CDMA, GSM, Bluetooth, WiFi, etc.) which may use antenna 335 to perform the wireless communication. A single radio within the communication circuitry 330 may be used to communicate with multiple networks (e.g., LTE and CDMA networks, among other types). For example, the same radio may be used to communicate with a first wireless network (e.g., a third generation wireless network such as 3GPP2 CDMA2000) and a second wireless network (e.g., a fourth generation wireless network, such as LTE). As discussed below, the radio may periodically alternate between tuning to the first wireless network or the second wireless network. The two wireless networks may typically be provided by different base stations, but may possibly be provided by the same base station (e.g., which supports the wireless technology of the first and second wireless network).

The hardware and/or software of the UE 106 may be used to implement various embodiments described herein.

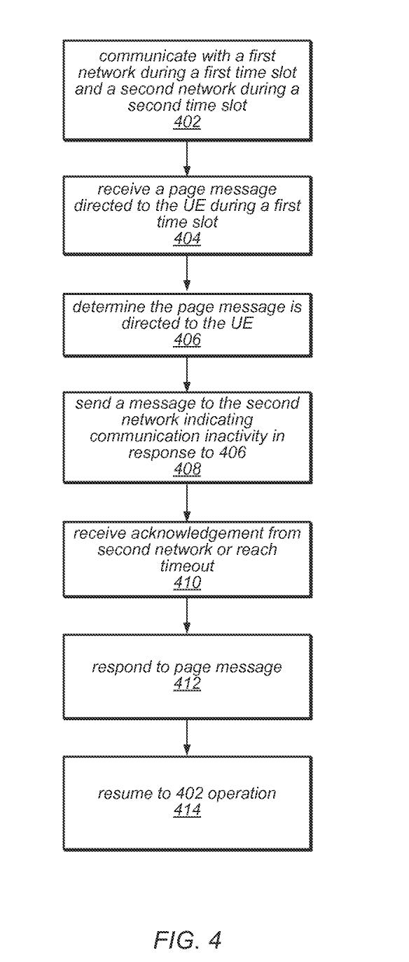

FIG. 4—Maintaining Communication of a UE Device Among Multiple Networks

FIG. 4 illustrates an exemplary method for performing wireless communication of a UE device using multiple wireless communication networks. The method shown in FIG. 4 may be used in conjunction with any of the computer systems or devices shown in the above Figures, among other devices. In various embodiments, some of the method elements shown may be performed concurrently, in a different order than shown, or may be omitted and/or considered optional. Additional method elements may also be performed as desired. As shown, this method may operate as follows.

In 402, a UE device (e.g., the UE device 106) may be configured to periodically communicate with a first wireless network and a second wireless network using a shared radio. The first wireless network may be a third generation wireless network, e.g., using a third generation wireless communication technology, such as CDMA, and the second wireless network may be a fourth generation wireless network, e.g., using a fourth generation wireless communication technology, such as LTE. Alternatively, the first and second wireless networks may be fourth and third generation communication technologies, respectively. According to various embodiments, the first and second wireless technologies may be of any set of generations, whether the same or different. For example, the first wireless technology may be CDMA while the second wireless technology may be GSM. Virtually any wireless communication technology may be used for either of the first or second wireless communication networks.

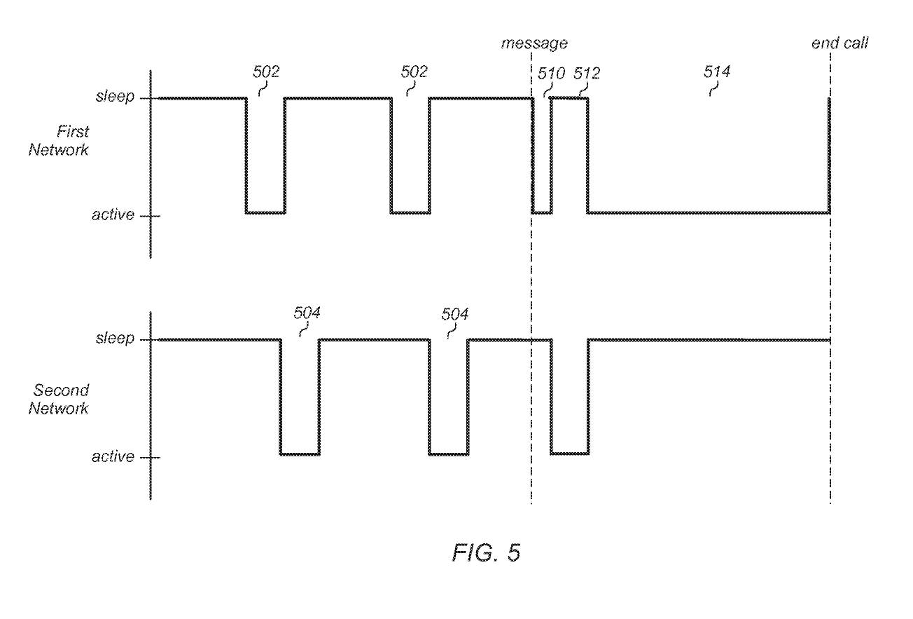

The UE device 106 may be configured to communicate with these networks using non-overlapping schedules. FIG. 5 illustrates an exemplary timing diagram that may be applicable to the method of FIG. 4. More specifically, as shown, prior to reception of a message from the first wireless network, discussed in more detail below, the UE device (e.g., the radio of the UE device) may periodically wake from sleep and performs wireless communication with the first wireless network during a first time slot 502 and then perform wireless communication with the second wireless network during the second time slot 504. The UE device 106 may then sleep until the next first time slot 502, e.g., in order to preserve battery life. During these communications, the UE device may be configured to receive messages from the wireless networks, update overhead variables or other communication parameters, etc. Thus, in one embodiment, the UE device may receive messages from the first wireless network in the first time slot and may receive messages from the second wireless network in the second, different time slot.

In 404, during one of the first time slots, the first UE device may receive a first message (e.g., a page message) directed to the UE device 106 from the first wireless network, shown in FIG. 5 at the dotted line labeled “message”. More specifically, the first message may identify that the first message is directed to the UE device 106 using an identification number or string of characters (referred to herein as an “ID”) associated with the UE device 106. The first message may be a general page message, whose format is included in the present third generation partnership project 2 (3GPP2) specification, C.S0005-E, version 3.0 from June 2011, which is hereby incorporated by reference as it fully and completely set forth herein.

Accordingly, in 406, the UE device 106 may determine that the received first message is directed to the UE device, e.g., based on the ID. More specifically, the UE device 106 may compare the ID indicated in the first message to its own ID to determine if there is a match. Where the ID of the first message does not match the ID of the UE device 106, the UE device 106 may ignore the first message and continue operating as discussed in 402. However, in the embodiment of FIG. 4, the UE device 106 may determine that the received first message is directed to the UE device 106. The received first message may indicate an incoming voice call, a short message service (SMS) message, an incoming data call, a service provisioning message, etc., that may require a response from the UE device (e.g., to answer the voice call).

However, because responding to the first message will use the single radio for an extended period of time, the UE device 106 may not be able to receive messages from or otherwise communicate with the second wireless network during that period of time. For example, where the first message indicates an incoming voice call, the single radio will be used for the voice call on the first wireless network and will not be available for receiving messages from or otherwise communicating with the second wireless network during the period of time.

Accordingly, before responding to the first message, in 408, the UE device 106 may send a message (e.g., an extended service request (ESR) message) to the second wireless network indicating that the UE device 106 will not be communicating with the second wireless network during the period of time. Said another way, when the UE device 106 receives the first message and determines that the first message is directed to the UE device 106, the UE device 106 may be in a first network communication mode for communicating with the first wireless network (e.g., where the stack associated with the first wireless network is in control of the radio or is otherwise active). Upon determining that the first message is directed to the UE device 106, the UE device 106 may switch to a second communication mode for communicating with the second wireless network. For example, the UE device 106 may transfer control of the radio from the first wireless network to the second wireless network (e.g., UE software associated with the first wireless network may no longer control the radio and instead UE software associated with the second wireless network may control the radio). Accordingly, the UE 106 may send the message to the second wireless network indicating that the UE 106 is suspending communication with the second wireless network to answer the first message from the first wireless network. The radio may be controlled by UE software associated with the second wireless network to send this message. Thus, while sending the message to the second wireless network, the UE device may not be able to monitor a paging channel or communicate with the first wireless network after receiving the first message, as would normally be the case.

The second message may be the ESR message defined at 3GPP TS 24.301 § 2.15, which is explained in greater detail in 3GPP TS 24.301, sections 5.61 and 8.2.15. The ESR message may indicate that the UE will be unavailable using the CSFB field. Further details regarding the CSFB procedure using ESR for mobile terminating calls is defined in 3GPP TS 23.272, chapter 7. Additionally, the CSFB field is defined in 3GPP TS 24.301, section 9.9.3.5. These sections can be found in the present 3GPP2 specification, which was incorporated by reference above. Note that in LTE or SAE embodiments, the second message may be sent to an MME of the core network via the eNB.

In 410, as an optional step, the UE device may either receive an acknowledgement of the message from the second wireless network or a threshold period of time may have elapsed for receiving the acknowledgement. Note that the UE device may not receive an explicit acknowledgement for the success case (although one is certainly possible). Instead, if the second network rejects the request of 408, a reject message, such as a NAS Service Reject message may be received by the UE device, indicating that the requested procedure (e.g., the ESR procedure) has failed. On the other hand, if the network accepts the request, a connection release message may be provided (e.g., an RRC Connection Release message), which may indicate to the UE that the requested procedure (e.g., the ESR procedure) has succeeded.

At this point, the UE device 106 may switch from the second communication mode (for communicating with the second wireless network using the shared radio) to the first communication mode (for communicating with the first wireless network using the shared radio). As indicated above, this may be achieved by UE software associated with performing communication over the second wireless network (e.g., a “second wireless network stack”) relinquishing control of the shared radio to UE software associated with performing communication over the first wireless network (e.g., a “first wireless network stack”).

In 412, the UE device 106 may respond to the first message from the first wireless network. For example, where the first message indicates an incoming voice call for the UE device 106, the UE device 106 may respond to the first message in order to accept or participate in the voice call. Similar responses may occur for other types of incoming messages (e.g., receiving an SMS message, a data call, etc.). The response to the first message may be a Page Response Message, as defined in C.S0005 in the present 3GPP2 specification, incorporated by reference above.

Finally, in 414, after completion of any activities associated with the first message, the UE device 106 may return to normal operation, e.g., as described above regarding 402. In one embodiment, in 414, the UE device 106 may send a message to the second wireless network indicating a resumption of communication by the UE device 106, e.g., that the UE device 106 may again communicate or receive messages during the second time slot 504.

The descriptions of 404-414 are shown graphically in FIG. 5, after the message is received and up to the end of the call, both shown with dotted lines. More specifically, in 510, the UE device 106 determines that the first message is directed to the UE device 106 and may perform other maintenance procedures, such as updating overhead variables. In 512, the first network portion of the UE device 106 may enter a sleep state while the second network portion of the UE device 106 may become active and send out the message indicated in 408. Additionally, during 512, the UE device 106 may wait for and/or receive a response to that message from the second wireless network. After 512, the first network portion of the UE device 106 may enter an active state and respond to the first message and perform any associated actions, such as participating in a voice call. Finally, after 514 ends, normal behavior may be resumed.

The method of FIG. 4 may be performed by the UE device 106 using any of various implementations. For example, the method of FIG. 4 may be implemented in software or firmware of the UE device and may control the radio to perform communication with the first and second wireless networks. Alternatively, the method of FIG. 4 may be implemented using dedicated circuitry, such as using a field programmable gate array (FPGA) or integrated circuit (e.g., an application specific integrated circuit (ASIC)), or any combination of the above.

### Exemplary Message Flow Related to Second Wireless Network

The following provides one specific example illustrating message flow in a successful case for the UE device. Note that the following is exemplary only and does not limit the descriptions provided herein, particularly those provided with regard to FIGS. 4 and 5.

The UE device may send an ESR message including a CSFB field to the second wireless network.

The UE device may request for RRC connection for sending the ESR message.

The second wireless network may respond by sending an “RRC connection setup” message.

The ESR message may be encoded in an “RRC Connection Setup Complete” message.

On successful ESR procedure, the second network may send an “RRC Connection Release” message.

### Further Embodiments

Note that in the present description, various embodiments are described in the context of LTE and CDMA. However, it is noted that the methods described herein can be generalized for any set of wireless communication technologies involving shared use of a radio and/or antenna, and/or any other appropriate context.

Embodiments of the described herein may be realized in any of various forms. For example, the systems and methods described herein may be realized as a computer-implemented method, a computer-readable memory medium, or a computer system. Alternatively, the systems and methods described herein may be realized using one or more custom-designed hardware devices such as ASICs. As another alternative, the systems and methods described herein may be realized using one or more programmable hardware elements such as FPGAs. The systems and methods described herein may also be implemented using any combination of the above.

In some embodiments, a non-transitory computer-readable memory medium may be configured so that it stores program instructions and/or data, where the program instructions, if executed by a computer system, cause the computer system to perform a method, e.g., any of a method embodiments described herein, or, any combination of the method embodiments described herein, or, any subset of any of the method embodiments described herein, or, any combination of such subsets.

In some embodiments, a device (e.g., a UE) may be configured to include a processor (or a set of processors) and a memory medium, where the memory medium stores program instructions, where the processor is configured to read and execute the program instructions from the memory medium, where the program instructions are executable to implement any of the various method embodiments described herein (or, any combination of the method embodiments described herein, or, any subset of any of the method embodiments described herein, or, any combination of such subsets). The device may be realized in any of various forms.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A method for performing wireless communication by a user equipment (UE) device for communicating with a first wireless network and a second wireless network using a single radio, the method comprising:
the UE device receiving a page message directed to the UE device from the first wireless network, wherein the receiving the page message uses the single radio;
in response to receiving the page message, the UE device transmitting an extended service request (ESR) message to an LTE Mobility Management Entity (MME) via the second wireless network, the ESR message indicating that the UE device is suspending communication with the second wireless network, wherein the transmitting the ESR message uses the single radio;
after transmitting the ESR message, the UE device transmitting a page response message that is responsive to the page message via the first wireless network, wherein the transmitting the page response message uses the single radio.

2. The method of claim 1, further comprising:
the UE device receiving a response to the ESR message from the second wireless network, wherein the responding to the page message is performed after the receiving the response to the ESR message.

3. The method of claim 1, wherein the responding to the page message is performed after a response to the ESR message has not been received within a threshold amount of time.

4. The method of claim 1, wherein the page message indicates an incoming voice call for the UE device, wherein the method further comprises answering the voice call.

5. The method of claim 1, wherein the page message indicates an incoming short message service (SMS) message directed to the UE device.

6. The method of claim 18, further comprising:
resuming communication with the second wireless network.

7. A non-transitory, computer accessible memory medium storing program instructions for performing wireless communication by a user equipment (UE) device communicating with a first wireless network and a second wireless network using a single radio, wherein the program instructions are executable by a processor to:
receive a first message directed to the UE device from the first wireless network, wherein the receiving the first message uses the single radio;
in response to receiving the first message, provide a message to the second wireless network indicating the UE device is suspending communication with the second wireless network, wherein the providing the message uses the single radio;
after providing the message, respond to the first message on the first wireless network, wherein the responding to the first message uses the single radio.

8. The non-transitory, computer accessible memory medium of claim 7, wherein the message comprises extended service request (ESR) message

9. The non-transitory, computer accessible memory medium of claim 7, wherein the first wireless network utilizes a third generation wireless communication technology and the second wireless network utilizes a fourth generation wireless communication technology.

10. The non-transitory, computer accessible memory medium of claim 7, wherein the first wireless network comprises a 3GPP2 code division multiple access (CDMA) wireless network.

11. The non-transitory, computer accessible memory medium of claim 7, wherein the second wireless network comprises a long term evolution (LTE) wireless network.

12. The non-transitory, computer accessible memory medium of claim 7, wherein the first message indicates an incoming voice call directed to the UE device.

13. The non-transitory, computer accessible memory medium of claim 7, wherein the first message indicates an incoming short message service (SMS) message directed to the UE device.

14. The non-transitory, computer accessible memory medium of claim 7, wherein the program instructions are further executable to:
resume communication with the second wireless network after completing actions associated with the first message.

15. A device, comprising:
a radio for performing wireless communication on a first wireless network and a second wireless network;
a controller coupled to the radio, wherein the controller is configured to:
receive a page message directed to the device from the first wireless network using the radio;
determine that the page message is directed to the device;
in response to determining that the page message is directed to the device, provide a message to the second wireless network using the radio, wherein the message indicates that the device is suspending communication with the second wireless network;
after providing the message, respond to the page message on the first wireless network using the radio.

16. The device of claim 15, wherein the controller is implemented as an integrated circuit.

17. The device of claim 15, wherein the controller comprises a processor and a memory medium storing program instructions executable by the processor to perform the receiving, the determining, the providing, and the responding.

18. The device of claim 15, wherein the determining comprises comparing an identification value comprised in the page message with an identification value associated with the device.

19. The device of claim 15, wherein the message comprises an extended service request (ESR) message.

20. The device of claim 15, wherein the controller is further configured to perform the responding to the page message after a response to the message is received or after a threshold amount of time has passed since providing the message.

21. A method for performing wireless communication by a user equipment (UE) device communicating with a first wireless network and a second wireless network using a single radio, comprising:
the UE device communicating with the first wireless network using the single radio during first time slots;
the UE device communicating with the second wireless network using the single radio during second time slots;
during a first one of the first time slots, the UE device receiving a page message directed to the UE device from the first wireless network, wherein the receiving the page message uses the single radio;
in response to receiving the page message, the UE device providing an extended service request (ESR) message to the second wireless network indicating the UE device is suspending communication with the second wireless network, wherein the providing the ESR message uses the single radio;
after providing the ESR message, the UE device responding to the page message on the first wireless network, wherein the responding to the page message uses the single radio.

22. The method of claim 21, wherein while communicating with the first wireless network, first software controls the single radio, wherein while communicating with the second wireless network, second software controls the single radio.

23. The method of claim 22, wherein the radio enters a sleep state when not being used for communication with the first or second wireless network.

24. The method of claim 22, further comprising:
the first software entering a sleep state and the second software entering an active state after the receiving the page message; and
the second software entering a sleep state and the first software entering an active state after the providing the ESR message.

25. A mobile handset, comprising:
a radio for performing wireless communication on a first wireless network or a second wireless network;
a processor coupled to the radio;
a memory medium coupled to the processor, wherein the memory medium stores first program instructions executable by the processor to perform communication with the first wireless network and second program instructions executable by the processor to perform communication with the second wireless network;
wherein the first program instructions are executable to receive a page message directed to the UE device from the first wireless network;
wherein the second program instructions are executable to provide an extended service request (ESR) message to the second wireless network in response to the page message;
wherein the first program instructions are executable to respond to the page message after the ESR message is provided to the second wireless network.
